(19) United States
(12) Patent Application Publication
(10) Pub. No.: US 2024/0216951 A1
(43) Pub. Date: Jul. 4, 2024

(54) ELECTROSTATIC TRANSDUCER

(71) Applicant: Sumitomo Riko Company Limited, Aichi (JP)

(72) Inventors: Katsuhiko Nakano, Aichi (JP); Shinya Tahara, Aichi (JP); Masaki Nasu, Aichi (JP)

(73) Assignee: Sumitomo Riko Company Limited, Aichi (JP)

(21) Appl. No.: 18/608,912

(22) Filed: Mar. 18, 2024

Related U.S. Application Data
(63) Continuation of application No. PCT/JP23/02288, filed on Jan. 25, 2023.

(30) Foreign Application Priority Data
Jan. 27, 2022 (JP) 2022-011226

(51) Int. Cl. B06B 1/02

(52) U.S. Cl. CPC B06B 1/0292

(57) ABSTRACT

An electrostatic transducer includes: a first insulator sheet formed containing a thermoplastic elastomer; an electrode sheet disposed on a first surface of the first insulator sheet; and a heater-cum-shield wire that is joined to a second surface of the first insulator sheet by fusion of the first insulator sheet itself, and that serves both as a heater wire and a shield electrode wire.

### CROSS-REFERENCE TO RELATED APPLICATION

This application is a continuation of PCT International Application No. PCT/JP2023/002288, filed on Jan. 25, 2023, which claims priority under 35 U.S.C § 119(a) to Japanese Patent Application No. 2022-011226, filed on Jan. 27, 2022. Each of the above application(s) is hereby expressly incorporated by reference, in its entirety, into the present application.

### BACKGROUND

### Technical Field

The present disclosure relates to an electrostatic transducer.

### Related Art

WO 2020/194670 describes an electrostatic transducer which includes an insulator sheet made of an elastomer, a first electrode sheet disposed on a front surface of the insulator sheet, a second electrode sheet disposed on a back surface of the insulator sheet, and a heater disposed on a back surface of the second electrode sheet.

By having a heater function, the electrostatic transducer is increased in thickness. It is desired that the electrostatic transducer be reduced in size while having the heater function.

### SUMMARY

One aspect of the present disclosure provides an electrostatic transducer including: a first insulator sheet, formed containing a thermoplastic elastomer; an electrode sheet, disposed on a first surface of the first insulator sheet; and a heater-cum-shield wire, joined to a second surface of the first insulator sheet by fusion of the first insulator sheet itself, and serving both as a heater wire and a shield electrode wire.

### BRIEF DESCRIPTION OF THE DRAWINGS

FIG. 1 is a plan view of an electrostatic transducer according to Embodiment 1.

FIG. 2 is an enlarged sectional view taken along line II-II in FIG. 1.

FIG. 3 is an enlarged view of portion III in FIG. 1.

FIG. 4 is a sectional view taken along line IV-IV in FIG. 3.

FIG. 5 is a sectional view taken along line V-V in FIG. 3.

FIG. 6 is a plan view of an electrostatic transducer according to Embodiment 2.

### DESCRIPTION OF THE EMBODIMENTS

The present disclosure provides an electrostatic transducer that can be reduced in size while having a heater function.

According to the present disclosure, the heater-cum-shield wire serves both as a heater wire and a shield electrode wire. Accordingly, the electrostatic transducer can be reduced in size compared to a case where the heater wire and the shield electrode wire are separately provided.

Furthermore, the heater-cum-shield wire is joined to the first insulator sheet by fusion of the first insulator sheet itself. Accordingly, adhesion between the heater-cum-shield wire and the first insulator sheet is increased, which contributes to size reduction of the electrostatic transducer. Furthermore, since the adhesion between the heater-cum-shield wire and the first insulator sheet is increased, heat generated by the heater-cum-shield wire can be efficiently transferred to the electrode sheet side via the first insulator sheet. Accordingly, thermal efficiency can be improved.

As described above, according to the above aspect, an electrostatic transducer can be provided that can be reduced in size while having a heater function.

Reference numerals in parentheses in the claims indicate correspondence with specific means described in the embodiments described later, and do not limit the technical scope of the present disclosure.

### Embodiment 1

### 1. Application Object

An electrostatic transducer includes, for example, a base material, and an electrostatic sheet attached to an attachment surface of the base material. The base material is any member and is made of metal, resin, or any other material.

The attachment surface of the base material may be formed in a three-dimensional shape such as a curved surface, a composite plane (a shape formed by a plurality of planes), or a composite shape of a plane and a curved surface, or may be formed in a single plane shape. In the case where the base material is made of a material having flexibility, the electrostatic sheet can also be attached to the attachment surface of the base material. The electrostatic transducer may be composed of the electrostatic sheet alone without including a base material.

The electrostatic sheet is disposed on the attachment surface (surface) of the base material. The electrostatic sheet is flexible as a whole. That is, the electrostatic sheet has flexibility and is configured to be extendable in a plane direction. Accordingly, even if the attachment surface of the base material has a three-dimensional shape, the electrostatic sheet can be attached along the attachment surface of the base material. Particularly, by attaching the electrostatic sheet to the attachment surface of the base material while extending the electrostatic sheet in the plane direction, the occurrence of wrinkles in the electrostatic sheet can be reduced.

The electrostatic sheet is configured to function as an actuator or a sensor by utilizing a change in capacitance between a pair of target electrodes. It is sufficient if the electrostatic sheet includes at least one of the pair of target electrodes, and is not limited to the configuration including a pair of target electrodes. In the present embodiment, the electrostatic sheet is configured to include a shield electrode. That is, as the electrostatic sheet, there are a first type which includes one of a pair of target electrodes and a shield electrode, a second type which includes a pair of target electrodes and a shield electrode, and the like. In the first type, the other target electrode may be an external electrical conductor.

The electrostatic sheet can be configured as an actuator that causes vibrations, sounds or the like to occur by utilizing a change in capacitance between the pair of target electrodes. The electrostatic sheet can be configured as, for example, a sensor that detects external pushing force or the like or a sensor that detects contact or approach of a conductor having a potential, by utilizing a change in capacitance between target electrodes.

If the electrostatic sheet is configured as an actuator, by applying a voltage to the target electrodes, an insulator is deformed according to a potential between the target electrodes, and vibrations occur as the insulator is deformed. If the electrostatic sheet is configured as a sensor that detects pushing force, the capacitance between the target electrodes changes due to deformation of an insulator caused by input of external pushing force, vibrations, and sounds or the like (hereinafter external pushing force or the like). By detecting a voltage according to the capacitance between the target electrodes, the external pushing force or the like is detected.

If the electrostatic sheet is configured as a sensor that detects contact or approach, the capacitance between the target electrodes changes due to contact or approach of a conductor having a potential. By detecting a voltage according to the changed capacitance between the target electrodes, the contact or approach of said conductor is detected.

The electrostatic transducer can be applied to, for example, a surface of a mouse or joystick which is a pointing device, or a surface of a vehicle part. Examples of the vehicle part include an armrest, a doorknob, a shift lever, a steering wheel, a door trim, a center trim, a center console, and a ceiling. In many cases, the base material is made of a material having no flexibility, such as metal or hard resin. The electrostatic transducer can be configured to detect a state of a target or apply vibrations or the like to the target.

The electrostatic transducer may be disposed on a seat surface or a back surface of a seat in order to detect a state of a person sitting on the seat. In this case, the electrostatic transducer may be configured so that the electrostatic sheet alone is disposed on the seat, or the electrostatic sheet is attached to an arbitrary base material.

In the present embodiment, the electrostatic transducer has a heater function. Accordingly, the electrostatic transducer is able to not only detect the state of the target or apply vibrations or the like to the target, but also apply heat to the target.

### 2. Overall Configuration of Electrostatic Transducer 1

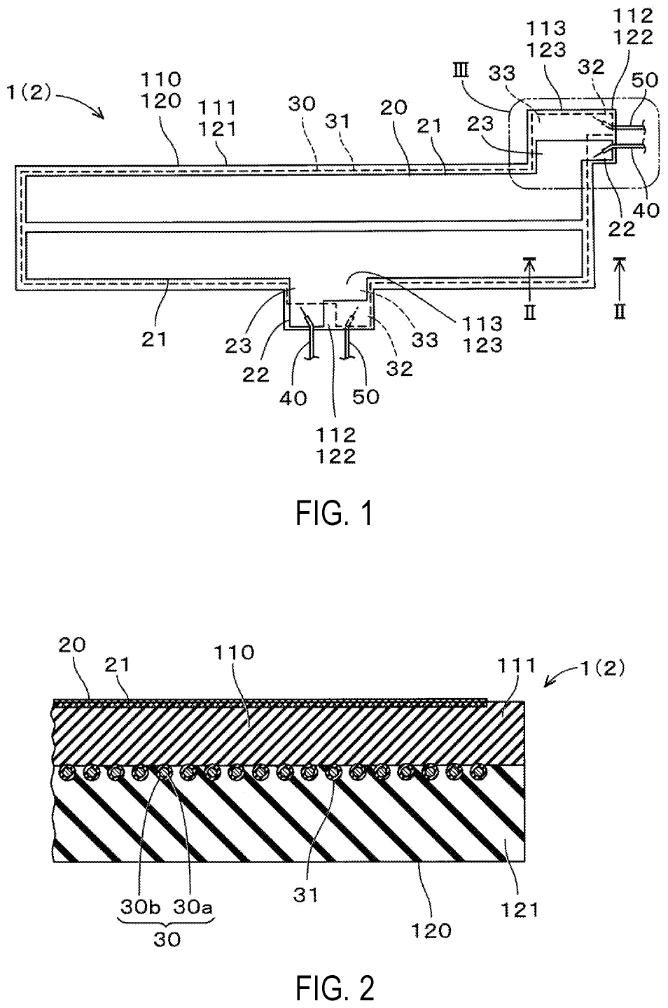

An overall configuration of an electrostatic transducer 1 of Embodiment 1 is described with reference to FIG. 1 and FIG. 2. In FIG. 2, thickness is exaggeratedly illustrated to facilitate the description. The electrostatic transducer 1 includes at least an electrostatic sheet 2. The electrostatic sheet 2 may be disposed on a surface of a base material (not illustrated), or may be used alone.

In FIG. 1, the electrostatic sheet 2 is formed in a long planar shape. However, since the electrostatic sheet 2 has flexibility and is configured to be extendable, the electrostatic sheet 21 can be of any shape. That is, the electrostatic sheet 2 shown in FIG. 1 shows an initial shape before deformation.

The electrostatic sheet 2 includes at least a first insulator sheet 110, an electrode sheet 20, a heater-cum-shield wire 30, a second insulator sheet 120, a first lead wire 40, and a second lead wire 50. In the present embodiment, a case is described as an example where the electrostatic sheet 2 includes a plurality of (for example, two) electrostatic sheets 20 and one heater-cum-shield wire 30, and further includes a plurality of (for example, two) first lead wires 40 and a plurality of (for example, two) second lead wires 50.

The first insulator sheet 110 is formed containing, for example, an elastomer, as a main component. Accordingly, the first insulator sheet 110 is flexible. That is, the first insulator sheet 110 has flexibility and is configured to be extendable in the plane direction. The first insulator sheet 110 is formed containing, for example, a thermoplastic material (particularly a thermoplastic elastomer), as a main component. The first insulator sheet 110 may be formed of the thermoplastic elastomer itself, or may be formed having, as a main component, an elastomer crosslinked by heating the thermoplastic elastomer as a raw material.

The first insulator sheet 110 may contain rubber and resin other than thermoplastic elastomers, or any other material. For example, if the first insulator sheet 110 includes rubber such as ethylene-propylene rubber (EPM, EPDM), the flexibility of the first insulator sheet 110 is improved. From the viewpoint of improving the flexibility of the first insulator sheet 110, the first insulator sheet 110 may contain a flexibility imparting component such as a plasticizer.

Furthermore, the first insulator sheet 110 preferably includes a material having good thermal conductivity. Accordingly, the first insulator sheet 110 may use a thermoplastic elastomer having high thermal conductivity, or may contain a filler capable of increasing thermal conductivity.

The first insulator sheet 110 includes a first insulating main body 111, a plurality of (for example, two) first insulating terminals 112, and a plurality of (for example, two) first insulating intermediate portions 113. The first insulating main body 111 is formed in a planar shape and constitutes a region that functions as an actuator or a sensor. Each first insulating terminal 112 constitutes a region where the first lead wire 40 and the second lead wire 50 are joined. The first insulating terminal 112 is indirectly connected to the first insulating main body 111, and is formed outside a side of the first insulating main body 111 in the plane direction. Each first insulating intermediate portion 113 constitutes a region connecting the first insulating main body 111 and the first insulating terminal 112. The first insulating intermediate portion 113 is interposed between the first insulating main body 111 and the first insulating terminal 112 in the plane direction of the first insulator sheet 110. The first insulating terminal 112 may be directly connected to the first insulating main body 111. In this case, the first insulating intermediate portion 113 is not present.

One first insulating terminal 112 and one first insulating intermediate portion 113 are formed to extend outward in a lateral direction of the first insulating main body 111 from an intermediate portion in a longitudinal direction of the first insulating main body 111. Another first insulating terminal 112 and another first insulating intermediate portion 113 are formed to extend outward from near an end in the longitudinal direction on a longitudinal side of the first insulating main body 111. However, the arrangement of the first insulating terminal 112 and the first insulating intermediate portion 113 can be arbitrarily set.

The plurality of electrode sheets 20 are arranged in the plane direction of the first insulator sheet 110 on a first surface of the first insulator sheet 110, that is, a front surface (front surface in FIG. 1; upper surface in FIG. 2) side of the first insulator sheet 110. The electrode sheet 20 constitutes a detection electrode. The electrode sheet 20 is electrically conductive. Furthermore, the electrode sheet 20 is flexible. That is, the electrode sheet 20 has flexibility and is configured to be extendable in the plane direction. The electrode sheet 20 is made of, for example, conductive cloth, conductive elastomer, or metal foil.

In FIG. 2, a case is illustrated where the electrode sheet 20 is conductive cloth. The case where the electrode sheet 20 is made of conductive cloth is described in detail. The conductive cloth is a woven fabric or a nonwoven fabric made of conductive fibers. Here, the conductive fibers are formed by covering a surface of flexible fibers with an electrically conductive material. The conductive fibers are formed, for example, by plating a surface of resin fibers such as polyethylene fibers with copper, nickel or the like.

In this case, the electrode sheet 20 is joined to the first insulator sheet 110 by fusion (thermal fusion) of the first insulator sheet 110 itself. Furthermore, since the electrode sheet 20 is cloth, it has a plurality of through holes. Accordingly, a portion of the first insulator sheet 110 enters the through holes of the electrode sheet 20. That is, at least a portion of the electrode sheet 20 is embedded in the first insulator sheet 110.

A case where the electrode sheet 20 is made of a conductive elastomer is described in detail. In this case, the electrode sheet 20 is formed by using an elastomer as a base material and containing a conductive filler. The elastomer which is the base material of the electrode sheet 20 preferably has the same kind of main component as the first insulator sheet 110. Particularly, the electrode sheet 20 is preferably made of a thermoplastic elastomer.

However, the electrode sheet 20 is made of a material having a softening point higher than that of the first insulator sheet 110. The reason is that, when the electrode sheet 20 is joined to the first insulator sheet 110 by fusion (thermal fusion) of the first insulator sheet 110 itself, the first insulator sheet 110 is to be softened before the electrode sheet 20. As a result, a thickness of the first insulator sheet 110 can be set to a desired thickness.

Here, the electrode sheet 20 is joined to the first insulator sheet 110 by fusion (thermal fusion) of the first insulator sheet 110 itself. Furthermore, if the electrode sheet 20 is formed so that the elastomer is located in a surface layer, the electrode sheet 20 and the first insulator sheet 110 are joined by fusion (thermal fusion) of the electrode sheet 20 itself. That is, the electrode sheet 20 and the first insulator sheet 110 are joined by mutual fusion. The electrode sheet 20 and the first insulator sheet 110 may be joined by fusion of only one of them.

A case where the electrode sheet 20 is made of metal foil is described in detail. Like the conductive cloth, the metal foil preferably has a plurality of through holes. Accordingly, the electrode sheet 20 has flexibility and is able to extend in the plane direction as the through holes are deformed. It is sufficient if the metal foil is a conductive metal material. For example, copper foil or aluminum foil can be applied. Furthermore, as in the case of conductive cloth, the electrode sheet 20 is joined to the first insulator sheet 110 by fusion (thermal fusion) of the first insulator sheet 110 itself.

As shown in FIG. 1, each electrode sheet 20 includes an electrode main body 21, an electrode terminal 22, and an electrode intermediate portion 23. The electrode main body 21 is formed in a planar shape. Each of a plurality of electrode main bodies 21 is disposed overlapping the first insulating main body 111 of the first insulator sheet 110. The electrode terminal 22 is indirectly connected to the electrode main body 21, is formed outside a side of the electrode main body 21 in the plane direction, and is disposed overlapping the first insulating terminal 112 of the first insulator sheet 110.

The electrode intermediate portion 23 connects the electrode main body 21 and the electrode terminal 22. That is, the electrode intermediate portion 23 is interposed between the electrode main body 21 and the electrode terminal 22 in the plane direction of the electrode sheet 20. The electrode intermediate portion 23 is disposed overlapping the first insulating intermediate portion 113. The electrode terminal 22 may be directly connected to the electrode main body 21. In this case, the electrode intermediate portion 23 is not present.

One heater-cum-shield wire 30 is disposed on a second surface of the first insulator sheet 110, that is, a back surface (back surface in FIG. 1; lower surface in FIG. 2) side of the first insulator sheet 110. In FIG. 1, the heater-cum-shield wire 30 is illustrated in a planar shape for convenience. The heater-cum-shield wire 30 is wired within a region illustrated in a planar shape. The heater-cum-shield wire 30 is configured to serve both as a heater wire and a shield electrode wire. The heater-cum-shield wire 30 is formed to have thermal resistance in order to function as the heater wire. Furthermore, the heater-cum-shield wire 30 is configured to function as a shield electrode by applying a predetermined voltage.

As shown in FIG. 2, the heater-cum-shield wire 30 is configured to include, for example, a conductive wire 30a, and a conductive wire covering material 30b covering the conductive wire 30a. In order to have thermal resistance, the conductive wire 30a includes, for example, a core wire, and a peripheral line spirally wound around the core wire. However, the conductive wire 30a is not limited to said configuration. It is sufficient if the conductive wire 30a is electrically conductive and has thermal resistance.

Furthermore, the heater-cum-shield wire 30 is flexible. That is, the heater-cum-shield wire 30 has flexibility and is configured to be extendable in the plane direction. The heater-cum-shield wire 30 is made of, for example, conductive cloth, conductive elastomer, or metal foil.

A portion of the heater-cum-shield wire 30 is disposed in contact with the first insulator sheet 110. A portion of the heater-cum-shield wire 30 may be embedded in the first insulator sheet 110. Accordingly, the heater-cum-shield wire 30 is able to directly transfer heat to the first insulator sheet 110.

Particularly, the conductive wire covering material 30b of the heater-cum-shield wire 30 is joined to the first insulator sheet 110 by fusion (thermal fusion) of the first insulator sheet 110 itself. Furthermore, if the conductive wire covering material 30b of the heater-cum-shield wire 30 is formed containing a thermoplastic elastomer, the heater-cum-shield wire 30 and the first insulator sheet 110 are joined by fusion (thermal fusion) of the conductive wire covering material 30b itself of the heater-cum-shield wire 30. That is, the heater-cum-shield wire 30 and the first insulator sheet 110 are joined by mutual fusion. The heater-cum-shield wire 30 and the first insulator sheet 110 may be joined by fusion of only one of them.

As shown in FIG. 1, the heater-cum-shield wire 30 includes one heater main body 31, a plurality of heater terminals 32, and a plurality of heater intermediate portions 33. The heater main body 31 is formed in a planar shape. The heater main body 31 is disposed overlapping the first insulating main body 111 of the first insulator sheet 110. Furthermore, one heater main body 31 is disposed to face substantially the entire surface of a plurality of electrode main bodies 21.

The plurality of heater terminals 32 are provided in the same number as the plurality of electrode terminals 22. Each of the plurality of heater terminals 32 is indirectly connected to the heater main body 31, is formed outside a side (a side of a region where the heater main body 31 is disposed in a planar shape) of the heater main body 31 in the plane direction, and is disposed overlapping the first insulating terminal 112 of the first insulator sheet 110. In the plane direction of the first insulating terminal 112 of the first insulator sheet 110, each of the plurality of heater terminals 32 is disposed at a position spaced apart from each of the plurality of electrode terminals 22. That is, when viewed in a normal direction of the first insulating terminal 112 of the first insulator sheet 110, the plurality of electrode terminals 22 and the plurality of heater terminals 32 are located at different positions. The reason for this is to reduce the thickness of the electrostatic sheet 2 due to the presence of the first lead wire 40 and the second lead wire 50 described later.

Each of the plurality of heater intermediate portions 33 connects the heater main body 31 and the heater terminal 32. That is, the heater intermediate portion 33 is interposed between the heater main body 31 and the heater terminal 32 in the plane direction of the heater-cum-shield wire 30. The heater intermediate portion 33 is disposed overlapping the first insulating intermediate portion 113. The heater intermediate portion 33 is disposed to have at least a portion facing the electrode intermediate portion 23. The heater intermediate portion 33 may be disposed so that an entirety thereof faces the electrode intermediate portion 23. The heater terminal 32 may be directly connected to the heater main body 31. In this case, the heater intermediate portion 33 is not present.

The second insulator sheet 120 is disposed on the second surface of the first insulator sheet 110, that is, the back surface (back surface in FIG. 1; lower surface in FIG. 2) side of the first insulator sheet 110. Furthermore, the second insulator sheet 120 is disposed opposite to the electrode sheet 20 with respect to the heater-cum-shield wire 30. That is, the second insulator sheet 120 and the first insulator sheet 110 sandwich the heater-cum-shield wire 30 therebetween. In the present embodiment, the second insulator sheet 120 is formed in the same planar shape as the first insulator sheet 110, and faces the first insulator sheet 110 over the entire surface. However, the second insulator sheet 120 may be of a different planar shape from the first insulator sheet 110.

The second insulator sheet 120 is formed containing, for example, an elastomer, as a main component. Accordingly, the second insulator sheet 120 is flexible. That is, the second insulator sheet 120 has flexibility and is configured to be extendable in the plane direction. The second insulator sheet 120 is formed containing, for example, a thermoplastic material (particularly a thermoplastic elastomer), as a main component. The second insulator sheet 120 may be formed of the thermoplastic elastomer itself, or may be formed having, as a main component, an elastomer crosslinked by heating the thermoplastic elastomer as a raw material.

The second insulator sheet 120 may contain rubber and resin other than thermoplastic elastomers, or any other material. For example, if the second insulator sheet 120 includes rubber such as ethylene-propylene rubber (EPM, EPDM), the flexibility of the second insulator sheet 120 is improved. From the viewpoint of improving the flexibility of the second insulator sheet 120, the second insulator sheet 120 may contain a flexibility imparting component such as a plasticizer.

The second insulator sheet 120 is joined to the second surface of the first insulator sheet 110 by fusion of the first insulator sheet 110 itself. If the second insulator sheet 120 is formed containing a thermoplastic elastomer, the first insulator sheet 110 and the second insulator sheet 120 are joined by fusion of the second insulator sheet 120 itself.

Furthermore, the second insulator sheet 120 is disposed in contact with a portion of the heater-cum-shield wire 30. Particularly, a portion of the heater-cum-shield wire 30 is embedded in the second insulator sheet 120. The second insulator sheet 120 is joined to the conductive wire covering material 30b of the heater-cum-shield wire 30 by fusion of the second insulator sheet 120 itself.

In FIG. 2, the heater-cum-shield wire 30 is set to be embedded deeper in the second insulator sheet 120 than in the first insulator sheet 110. However, the heater-cum-shield wire 30 may be embedded to about the same depth in the second insulator sheet 120 and the first insulator sheet 110, or may be embedded deeper in the first insulator sheet 110.

If the conductive wire covering material 30b of the heater-cum-shield wire 30 is formed containing a thermoplastic elastomer, the heater-cum-shield wire 30 and the second insulator sheet 120 are joined by fusion (thermal fusion) of the conductive wire covering material 30b itself of the heater-cum-shield wire 30. That is, the heater-cum-shield wire 30 and the second insulator sheet 120 are joined by mutual fusion. The heater-cum-shield wire 30 and the second insulator sheet 120 may be joined by fusion of only one of them.

Furthermore, the second insulator sheet 120 preferably includes a material having high thermal insulation properties. That is, the second insulator sheet 120 is formed to have lower thermal conductivity than the first insulator sheet 110. Particularly, the second insulator sheet 120 is preferably formed containing foamed resin as a material having lower thermal conductivity than the first insulator sheet 110. High thermal insulation performance can be exhibited by an air layer of the foamed resin.

In the case where the second insulator sheet 120 is made of foamed resin, a surface on the first insulator sheet 110 side is preferably formed in an open-cell state in which cells of the foamed resin are opened. In this case, the second insulator sheet 120 is joined to the first insulator sheet 110 by partial impregnation of the first insulator sheet 110. Accordingly, a joining force between the first insulator sheet 110 and the second insulator sheet 120 is increased. Furthermore, the second insulator sheet 120 may be joined to the heater-cum-shield wire 30 by partial impregnation of the conductive wire covering material 30b of the heater-cum-shield wire 30.

The second insulator sheet 120 includes a second insulating main body 121, a plurality of (for example, two) second insulating terminals 122, and a plurality of (for example, two) second insulating intermediate portions 123. The second insulating main body 121 is formed in a planar shape and constitutes a region that functions as an actuator or a sensor. Each second insulating terminal 122 constitutes a region where the first lead wire 40 and the second lead wire 50 are joined. The second insulating terminal 122 is indirectly connected to the second insulating main body 121, and is formed outside a side of the second insulating main body 121 in the plane direction. Each second insulating intermediate portion 123 constitutes a region connecting the second insulating main body 121 and the second insulating terminal 122. The second insulating intermediate portion 123 is interposed between the second insulating main body 121 and the second insulating terminal 122 in the plane direction of the second insulator sheet 120. The second insulating terminal 122 may be directly connected to the second insulating main body 121. In this case, the second insulating intermediate portion 123 is not present.

One second insulating terminal 122 and one second insulating intermediate portion 123 are formed to extend outward in the lateral direction of the second insulating main body 121 from an intermediate portion in the longitudinal direction of the second insulating main body 121. Another second insulating terminal 122 and another second insulating intermediate portion 123 are formed to extend outward from near an end in the longitudinal direction on a longitudinal side of the second insulating main body 121. However, the arrangement of the second insulating terminal 122 and the second insulating intermediate portion 123 can be arbitrarily set.

Each of the plurality of first lead wires 40 has a portion disposed overlapping the first surface of the first insulator sheet 110 and a portion disposed overlapping the electrode sheet 20. In detail, each of the plurality of first lead wires 40 is disposed overlapping each of the plurality of first insulating terminals 112 of the first insulator sheet 110. The first lead wire 40 is electrically connected to the electrode terminal 22 of the electrode sheet 20, and is electrically connected to the electrode main body 21 via the electrode intermediate portion 23. Furthermore, each of the plurality of first lead wires 40 is joined to the first insulating terminal 112 of the first insulator sheet 110.

Each of the plurality of second lead wires 50 has a portion disposed overlapping the second surface of the first insulator sheet 110 and a portion disposed overlapping the heater-cum-shield wire 30. In detail, each of the plurality of second lead wires 50 is disposed overlapping each of the plurality of first insulating terminals 112 of the first insulator sheet 110. The second lead wire 50 is electrically connected to the heater terminal 32 of the heater-cum-shield wire 30, and is electrically connected to the heater main body 31 via the heater intermediate portion 33. Furthermore, each of the plurality of second lead wires 50 is joined to the first insulating terminal 112 of the first insulator sheet 110. Each of the plurality of second lead wires 50 is disposed overlapping the second insulator sheet 120. In detail, each of the plurality of second lead wires 50 is disposed overlapping each of the plurality of second insulating terminals 122 of the second insulator sheet 120.

### 3. Detailed Configuration of Terminal Portion of Electrostatic Sheet 2

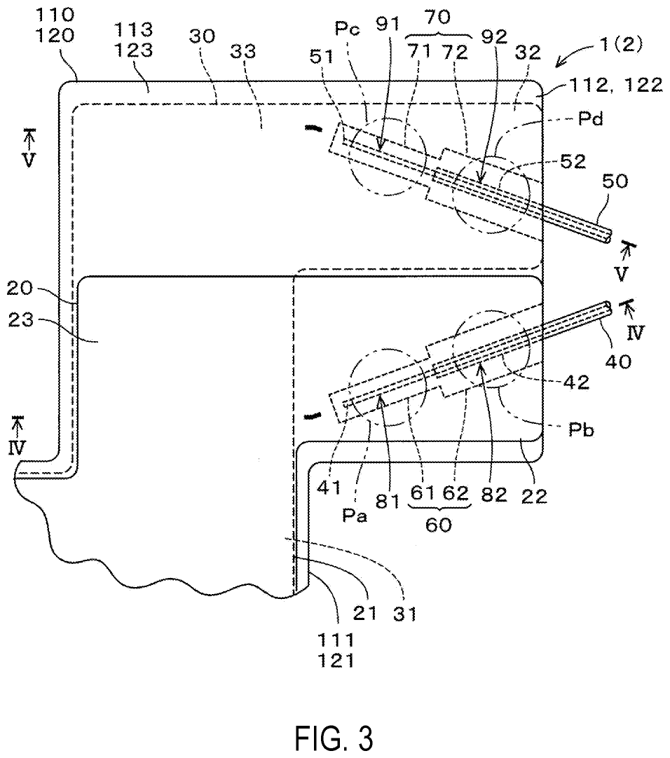

A detailed configuration of a terminal portion of the electrostatic sheet 2 constituting the electrostatic transducer 1 is described with reference to FIG. 3 to FIG. 5. FIG. 3 shows the terminal portion at the upper right in FIG. 1, and the detailed configuration of said terminal portion is described below. The terminal portion at the lower center in FIG. 1 also has a substantially similar configuration.

As described with reference to FIG. 1 and FIG. 2, the electrostatic sheet 2 includes at least the first insulator sheet 110, the electrode sheet 20, the heater-cum-shield wire 30, the second insulator sheet 120, the first lead wire 40, and the second lead wire 50. The electrostatic sheet 2 further includes a first joining restricting layer 60 and a second joining restricting layer 70.

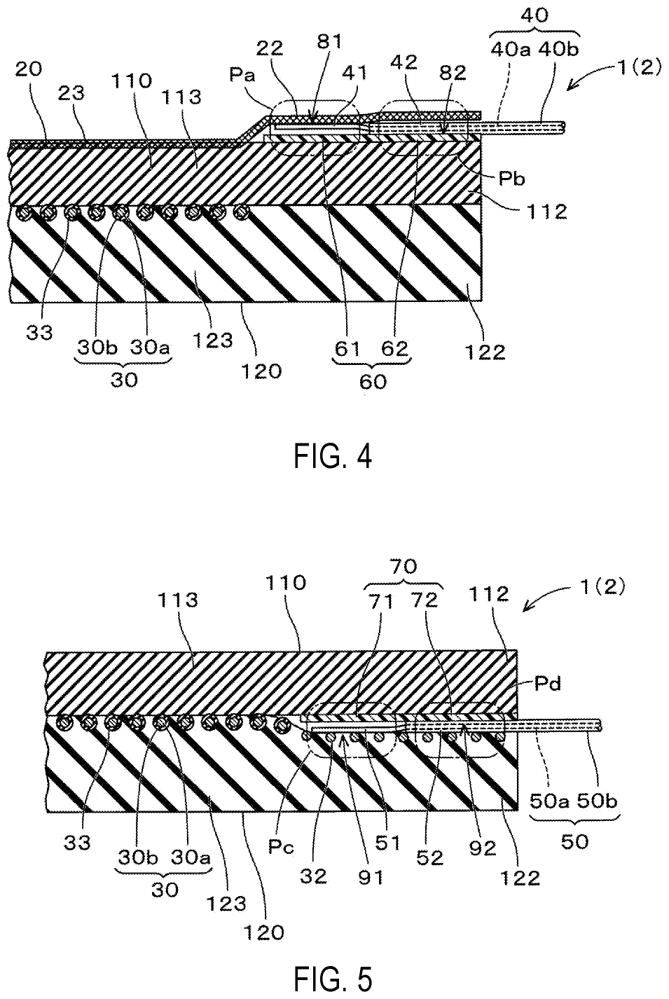

As shown in FIG. 3 and FIG. 4, the first joining restricting layer 60 is disposed between the first insulating terminal 112 of the first insulator sheet 110 and the electrode terminal 22 of the electrode sheet 20, and restricts the joining between the first insulator sheet 110 and the electrode sheet 20. Accordingly, in the electrode terminal 22 of the electrode sheet 20, in a region where the first joining restricting layer 60 is present, a space is formed between the electrode terminal 22 and the first joining restricting layer 60. On the other hand, in the electrode terminal 22 of the electrode sheet 20, in a region where the first joining restricting layer 60 is not present, the electrode terminal 22 is joined to the first insulator sheet 110.

The first joining restricting layer 60 is joined to the first insulator sheet 110 by fusion of the first insulator sheet 110 itself. Accordingly, the first joining restricting layer 60 is made of, for example, a material having a softening point higher than that of the first insulator sheet 110. For example, a resin sheet made of a thermoplastic material can be applied in the first joining restricting layer 60.

As shown in FIG. 3, the first joining restricting layer 60 is formed in an elongated shape. One end of the first joining restricting layer 60 in the longitudinal direction is disposed on an end side of the electrode terminal 22 of the electrode sheet 20. The other end of the first joining restricting layer 60 in the longitudinal direction is disposed to extend toward the electrode intermediate portion 23 of the electrode sheet 20 from the end side of the electrode terminal 22 of the electrode sheet 20. In the present embodiment, the other end of the first joining restricting layer 60 in the longitudinal direction is disposed to extend in a direction (particularly an oblique direction) intersecting the end side of the electrode sheet 20.

The first joining restricting layer 60 includes an inner part 61 formed small in width and an edge 62 formed large in width. In FIG. 3, the inner part 61 is formed to have the same width over the entire length, and the edge 62 is also formed to have the same width over the entire length. In addition, the width may be gradually reduced from a base end (end side of the electrode terminal 22 of the electrode sheet 20) of the edge 62 toward a tip of the inner part 61. The first joining restricting layer 60 may be formed in a flat plate shape, or may have a recess or a protrusion formed on one or both surfaces.

As shown in FIG. 4, the first lead wire 40 includes a first core wire 40a, and a first core wire covering material 40b insulatingly covering an outer peripheral surface of the first core wire 40a. The first core wire 40a is formed of, for example, a copper wire. The first core wire covering material 40b is formed containing a thermoplastic material. The first core wire covering material 40b may be any thermoplastic material having insulation properties, and is made of, for example, a material applicable to the first insulator sheet 110 described above.

A portion of the first lead wire 40 is disposed at the first insulating terminal 112 on the first surface (upper surface in FIG. 4) of the first insulator sheet 110. In the electrostatic sheet 2, since a portion of the first lead wire 40 is disposed in a region where the first insulating terminal 112 of the first insulator sheet 110 and the electrode terminal 22 of the electrode sheet 20 are both present, the portion of the first lead wire 40 is disposed overlapping the first insulating terminal 112 and also overlapping the electrode terminal 22.

If the electrode terminal 22 of the electrode sheet 20 has a region that is not disposed overlapping a portion of the first insulating terminal 112 of the first insulator sheet 110, the first lead wire 40 may have a portion disposed overlapping only the first insulating terminal 112 and a portion disposed overlapping the first insulating terminal 112 and the electrode terminal 22. In this case, the first lead wire 40 has at least a portion disposed overlapping the first insulating terminal 112 and a portion disposed overlapping the electrode terminal 22.

In the present embodiment, the first lead wire 40 is disposed between the first insulating terminal 112 and the electrode terminal 22. Particularly, since the first joining restricting layer 60 is disposed at the first insulating terminal 112, the first lead wire 40 is disposed between the first joining restricting layer 60 and the electrode terminal 22.

The first lead wire 40 includes, on a tip side of the first lead wire 40, a first core wire exposing part 41 from which the first core wire covering material 40b is removed and the first core wire 40a is exposed. The first lead wire 40 includes, on a base end side of the first core wire exposing part 41, a first core wire covering part 42 from which the first core wire covering material 40b is not removed.

The first core wire exposing part 41 may be configured as follows. The first core wire exposing part 41 has a metal plating layer formed on the first core wire 40a formed of a copper wire. In this case, nickel plating is suitable for the metal plating layer. The first core wire exposing part 41 may have a solder flow layer formed on the first core wire 40a. The metal plating layer and the solder flow layer serve to improve conduction with the electrode terminal 22.

The first core wire exposing part 41 of the first lead wire 40 is disposed in the inner part 61 of the first joining restricting layer 60. The first core wire covering part 42 is disposed in the edge 62 of the first joining restricting layer 60. The first lead wire 40 extends outward from the edge 62 of the first joining restricting layer 60.

Here, the first lead wire 40 is inserted into the space formed between the first joining restricting layer 60 and the electrode terminal 22, thereby being disposed in said position. The first joining restricting layer 60 has a large width in the edge 62 and a small width in the inner part 61. Accordingly, when the first lead wire 40 is inserted, the large width of the edge 62 facilitates initial insertion, and the small width of the inner part 61 allows the first lead wire 40 to be positioned in a desired position.

Furthermore, the electrostatic sheet 2 includes, in a first electrical joining region Pa where the electrode terminal 22 and the first core wire exposing part 41 of the first lead wire 40 are disposed adjacent to and overlapping each other in a region in the plane direction of the first insulating terminal 112, a first electrical joint 81 that electrically joins the electrode terminal 22 with the first core wire exposing part 41 of the first lead wire 40. That is, the first electrical joint 81 is disposed in a lamination region between the first insulating terminal 112 and the electrode terminal 22.

In the present embodiment, in the first electrical joining region Pa, the electrode terminal 22 and the first core wire 40a portion of the first core wire exposing part 41 are electrically joined via the metal plating layer or the solder flow layer. That is, the first electrical joint 81 is composed of a portion of the metal plating layer or a portion of the solder flow layer. Particularly, since the first electrical joint 81 is composed of a portion of the solder flow layer, the electrode terminal 22 and the first core wire 40a portion of the first core wire exposing part 41 are electrically joined surface-to-surface, and conduction can be improved.

Here, a portion of the first joining restricting layer 60 is disposed in the first electrical joining region Pa. Accordingly, after the first lead wire 40 is inserted between the electrode terminal 22 and the first joining restricting layer 60, by subjecting the first electrical joining region Pa to ultrasonic welding, the electrode terminal 22 and the first core wire exposing part 41 of the first lead wire 40 are electrically joined. Since the electrode terminal 22 and the first lead wire 40 have metal on their surfaces, they are joined by ultrasonic welding. On the other hand, while the first lead wire 40 and the first joining restricting layer 60 are adjacent to each other, since they are made of metal and resin, they are not welded even if being subjected to ultrasonic welding.

The electrostatic sheet 2 includes, in a first insulating joining region Pb where the first insulating terminal 112 and the first core wire covering part 42 of the first lead wire 40 are disposed overlapping each other in the region in the plane direction of the first insulating terminal 112, a first insulating joint 82 that joins the first insulating terminal 112 with the first core wire covering part 42 of the first lead wire 40. The first insulating joint 82 is disposed in the lamination region between the first insulating terminal 112 and the electrode terminal 22. However, the first insulating joint 82 is disposed in a different region from the first electrical joint 81 in the lamination region.

A portion of the first joining restricting layer 60 is disposed in the first insulating joining region Pb. A portion of the first joining restricting layer 60 is disposed between the first insulating terminal 112 and the first core wire covering part 42 of the first lead wire 40 in the first insulating joining region Pb. Accordingly, in the first insulating joining region Pb, the first insulating terminal 112 and the first joining restricting layer 60 are joined, and the first joining restricting layer 60 and the first core wire covering part 42 of the first lead wire 40 are joined. That is, the first insulating joint 82 includes a portion of the first insulating terminal 112, a portion of the first joining restricting layer 60, and a portion of the first core wire covering part 42. In this way, the first insulating joint 82 indirectly joins the first insulating terminal 112 with the first core wire covering part 42 through the first joining restricting layer 60.

After the first lead wire 40 is inserted between the electrode terminal 22 and the first joining restricting layer 60, by subjecting the first insulating joining region Pb to ultrasonic welding, the first insulating terminal 112 and the first joining restricting layer 60 are joined, and the first joining restricting layer 60 and the first core wire covering part 42 are joined. A processing condition for ultrasonic welding in the first insulating joint 82 is different from a processing condition for ultrasonic welding in the first electrical joint 81. While the processing condition in the first electrical joint 81 is to enable welding of the first core wire exposing part 41, the processing condition in the first insulating joint 82 is to prevent the first core wire 40a of the first core wire covering part 42 from being welded.

As shown in FIG. 3 and FIG. 5, the second joining restricting layer 70 is disposed between the first insulating terminal 112 of the first insulator sheet 110 and the heater terminal 32 of the heater-cum-shield wire 30, and restricts the joining between the first insulator sheet 110 and the heater-cum-shield wire 30. For example, in the heater terminal 32 of the heater-cum-shield wire 30, the conductive wire covering material 30b is removed, and the conductive wire 30a is exposed. Accordingly, the second joining restricting layer 70 restricts the joining between the first insulator sheet 110 and the conductive wire 30a of the heater-cum-shield wire 30. The second joining restricting layer 70 is configured substantially similarly to the first joining restricting layer 60. Like the first joining restricting layer 60, the second joining restricting layer 70 includes an inner part 71 and an edge 72.

As shown in FIG. 5, the second lead wire 50 includes a second core wire 50a, and a second core wire covering material 50b insulatingly covering an outer peripheral surface of the second core wire 50a. The second lead wire 50 includes, on a tip side of the second lead wire 50, a second core wire exposing part 51 from which the second core wire covering material 50b is removed and the second core wire 50a is exposed. The second lead wire 50 include a second core wire covering part 52 from which the second core wire covering material 50b is not removed. The second lead wire 50 is configured substantially similarly to the first lead wire 40.

The electrostatic sheet 2 includes, in a second electrical joining region Pc, a second electrical joint 91 that electrically joins the conductive wire 30a constituting the heater terminal 32 with the second core wire exposing part 51 of the second lead wire 50, and includes, in a second insulating joining region Pd, a second insulating joint 92 that indirectly joins the first insulating terminal 112 with the second core wire covering part 52 of the second lead wire 50 through the second joining restricting layer 70. The second electrical joint 91 and the second insulating joint 92 are substantially similar to the first electrical joint 81 and the first insulating joint 82 described above. The second electrical joining region Pc and the second insulating joining region Pd are substantially similar to the first electrical joining region Pa and the first insulating joining region Pb described above.

The second insulator sheet 120 is joined to the heater terminal 32 of the heater-cum-shield wire 30. In detail, the second insulator sheet 120 is joined with the conductive wire 30a constituting the heater terminal 32 in the second electrical joining region Pc. The second insulator sheet 120 is joined with the conductive wire 30a constituting the heater terminal 32 in the second insulating joining region Pd. The second insulator sheet 120 may or may not be joined to the second core wire covering material 50b of the second lead wire 50 in the second insulating joining region Pd. An appropriate selection can be made by adjusting joining conditions.

Accordingly, the second electrical joint 91 and the second insulating joint 92 are disposed in a lamination region between the first insulating terminal 112, the heater terminal 32 and the second insulating terminal 122. However, the second insulating joint 92 is disposed in a different region from the second electrical joint 91 in the lamination region.

Accordingly, the electrode terminal 22 and the heater terminal 32 are disposed spaced apart from each other in the plane direction of the first insulating terminal 112 of the first insulator sheet 110. That is, the first electrical joint 81 and the second electrical joint 91 are disposed spaced apart from each other in the plane direction of the first insulating terminal 112. Furthermore, the first insulating joint 82 and the second insulating joint 92 are disposed spaced apart from each other in the plane direction of the first insulating terminal 112.

### 4. Effects of Embodiment 1

According to the electrostatic transducer 1 of Embodiment 1, provided are: the first insulator sheet 110, formed containing a thermoplastic elastomer; the electrode sheet 20, disposed on the first surface of the first insulator sheet 110; and the heater-cum-shield wire 30, joined to the second surface of the first insulator sheet 110 by fusion of the first insulator sheet 110 itself, and serving both as a heater wire and a shield electrode wire.

In this way, the heater-cum-shield wire 30 serves both as a heater wire and a shield electrode wire. Accordingly, the electrostatic transducer 1 can be reduced in size compared to a case where the heater wire and the shield electrode wire are separately provided.

Furthermore, the heater-cum-shield wire 30 is joined to the first insulator sheet 110 by fusion of the first insulator sheet 110 itself. Accordingly, adhesion between the heater-cum-shield wire 30 and the first insulator sheet 110 is increased, which contributes to size reduction of the electrostatic transducer 1. In this way, the electrostatic transducer 1 can be reduced in size while having a heater function. Furthermore, since the adhesion between the heater-cum-shield wire 30 and the first insulator sheet 110 is increased, heat generated by the heater-cum-shield wire 30 can be efficiently transferred to the electrode sheet 20 side via the first insulator sheet 110. Accordingly, thermal efficiency can be improved.

The heater-cum-shield wire 30 includes the conductive wire 30a, and the conductive wire covering material 30b covering the conductive wire 30a. The conductive wire covering material 30b is joined to the second surface of the first insulator sheet 110 by fusion of the first insulator sheet 110 itself. Accordingly, the adhesion between the conductive wire covering material 30b of the heater-cum-shield wire 30 and the first insulator sheet 110 can be increased.

The electrostatic transducer 1 includes the second insulator sheet 120. The second insulator sheet 120 is formed to have lower thermal conductivity than the first insulator sheet 110, is disposed opposite to the electrode sheet 20 with respect to the heater-cum-shield wire 30, and is joined to the second surface of the first insulator sheet 110 by fusion of the first insulator sheet 110 itself. Since the thermal conductivity of the second insulator sheet 120 is lower than that of the first insulator sheet 110, heat from the heater-cum-shield wire 30 can be reliably transferred to the first insulator sheet 110 side.

A portion of the heater-cum-shield wire 30 is embedded in the second insulator sheet 120, and another portion of the heater-cum-shield wire 30 is in contact with or embedded in the first insulator sheet 110. Accordingly, the heater-cum-shield wire 30 can be reliably positioned.

The second insulator sheet 120 is formed containing foamed resin as a material having lower thermal conductivity than the first insulator sheet 110. Accordingly, the second insulator sheet 120 can be effectively used as a thermal insulation material.

In the second insulator sheet 120, the surface on the first insulator sheet 110 side is formed in the open-cell state in which cells of the foamed resin are opened. The second insulator sheet 120 is joined to the first insulator sheet 110 by partial impregnation of the first insulator sheet 110. Accordingly, the second insulator sheet 120 is able to exhibit a high joining force while having high thermal insulation performance.

The electrostatic transducer 1 includes the first lead wire 40. The first lead wire 40 includes the first core wire 40a, and the first core wire covering material 40b covering the first core wire 40a and formed containing a thermoplastic material. The first lead wire 40 has a portion disposed overlapping the first surface of the first insulator sheet 110 and a portion disposed overlapping the electrode sheet 20.

Furthermore, the electrostatic sheet 1 includes, in the first electrical joining region Pa which is a region in the plane direction of the first insulator sheet 110 and in which the electrode terminal 22 of the electrode sheet 20 and the first core wire 40a of the first lead wire 40 are disposed overlapping each other, the first electrical joint 81 that electrically joins the electrode terminal 22 of the electrode sheet 20 with the first core wire 40a of the first lead wire 40. The electrostatic sheet 1 includes, in the first insulating joining region Pb which is a different region from the first electrical joining region Pa in the plane direction of the first insulator sheet 110 and in which the first insulating terminal 112 of the first insulator sheet 110 and the first core wire covering material 40b of the first lead wire 40 are disposed overlapping each other, the first insulating joint 82 that joins the first insulating terminal 112 of the first insulator sheet 110 with the first core wire covering material 40b of the first lead wire 40.

That is, pull-out resistance of the first lead wire 40 mainly functions in the first insulating joint 82 in the first insulating joining region Pb. In this way, by making the portion for electrically joining the electrode terminal 22 with the first core wire 40a of the first lead wire 40 and the portion for ensuring the pull-out resistance of the first lead wire 40 to be separate portions, electrical joining and pull-out resistance can both be achieved. Accordingly, the first core wire 40a of the first lead wire 40 can be reliably electrically joined to the electrode terminal 22, and the pull-out resistance of the first lead wire 40 can be increased.

Particularly, the first insulating joint 82 is composed of a portion of the first insulator sheet 110. Accordingly, the first insulator sheet 110 and the first core wire covering material 40b of the first lead wire 40 can be joined without preparing another joining member.

A similar configuration is provided for the joining between the heater-cum-shield wire 30 and the second lead wire 50. Accordingly, the second core wire 50a of the second lead wire 50 can be reliably electrically joined to the heater-cum-shield wire 30, and the pull-out resistance of the second lead wire 50 can be increased.

Furthermore, the first electrical joint 81 and the second electrical joint 91 are disposed apart from each other in the plane direction of the first insulator sheet 110, and the first insulating joint 82 and the second insulating joint 92 are disposed apart from each other in the plane direction of the first insulator sheet 110. Accordingly, joining in the first electrical joint 81 and the second electrical joint 91 is facilitated, and joining in the first insulating joint 82 and the second insulating joint 92 is facilitated. Furthermore, the thickness of the first insulator sheet 110 can be reduced.

Accordingly, the first core wire 40a of the first lead wire 40 can be reliably electrically joined to the electrode sheet 20, and the pull-out resistance of the first lead wire 40 can be increased; the second core wire 50a of the second lead wire 50 can be reliably electrically joined to the heater-cum-shield wire 30, and the pull-out resistance of the second lead wire 50 can be increased.

The electrostatic transducer 1 includes, in the first electrical joining region Pa, the first joining restricting layer 60 that is disposed between the first insulating terminal 112 of the first insulator sheet 110 and the electrode terminal 22 of the electrode sheet 20 and restricts the joining between the first insulating terminal 112 of the first insulator sheet 110 and the electrode terminal 22 of the electrode sheet 20. By providing the first joining restricting layer 60, a bag-shaped portion can be easily formed between the first insulating terminal 112 of the first insulator sheet 110 and the electrode terminal 22 of the electrode sheet 20. With the first lead wire 40 inserted into the bag-shaped portion formed by the first insulating terminal 112 and the electrode terminal 22, the first lead wire 40 is joined to the first insulating terminal 112 and the electrode terminal 22. Accordingly, the first lead wire 40 can be easily positioned in the desired position, and reliable joining can be achieved. The second joining restricting layer 70 exhibits similar effects.

A portion of the first joining restricting layer 60 is disposed between the first insulator sheet 110 and the first core wire covering material 40b of the first lead wire 40 in the first insulating joining region Pb. The first insulating joint 82 is composed of a portion of the first joining restricting layer 60, a portion of the first insulator sheet 110, and a portion of the first core wire covering material 40b of the first lead wire 40. In the configuration including the first joining restricting layer 60, the first insulating joint 82 can be reliably formed. The same applies to the second insulating joint 92.

The first joining restricting layer 60 is made of a material having a softening point higher than that of the first insulator sheet 110. Accordingly, the first joining restricting layer 60 is joined to the first insulator sheet 110 by fusion of the first insulator sheet 110 itself. The same applies to the second joining restricting layer 70.

The first joining restricting layer 60 is a resin sheet formed containing a thermoplastic material. Accordingly, the first joining restricting layer 60 can be joined to the first insulator sheet 110. The same applies to the second joining restricting layer 70.

### Embodiment 2

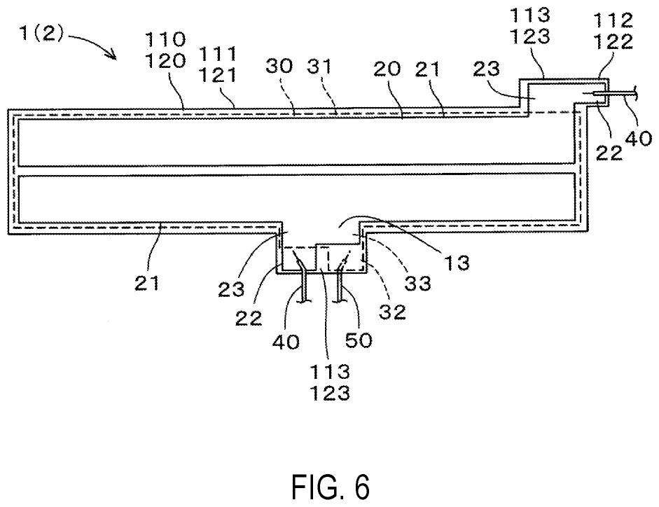

A configuration of the electrostatic transducer 1 of Embodiment 2 is described with reference to FIG. 6. In the electrostatic sheet 2 constituting the electrostatic transducer 1, the first insulator sheet 110 includes a plurality of first insulating terminals 112. Each of a plurality of electrode sheets 20 includes the electrode terminal 22. The heater-cum-shield wire 30 includes one heater terminal 32.

The electrode terminal 22 and the heater terminal 32 are disposed overlapping one of the plurality of first insulating terminals 112. On the other hand, while the electrode terminal 22 is disposed overlapping the rest of the plurality of first insulating terminals 112, the heater terminal 32 is not disposed in the rest of the plurality of first insulating terminals 112. Accordingly, by reducing the number of second lead wires 50, cost and size can reduced.

1. An electrostatic transducer (1) comprising:
a first insulator sheet (110), formed containing a thermoplastic elastomer;
an electrode sheet (20), disposed on a first surface of the first insulator sheet; and
a heater-cum-shield wire (30), joined to a second surface of the first insulator sheet by fusion of the first insulator sheet itself, and serving both as a heater wire and a shield electrode wire.

2. The electrostatic transducer according to claim 1, wherein
the heater-cum-shield wire comprises
a conductive wire (30a); and
a conductive wire covering material (30b), covering the conductive wire, wherein
the conductive wire covering material is joined to the second surface of the first insulator sheet by fusion of the first insulator sheet itself.

3. The electrostatic transducer according to claim 1, further comprising:
a second insulator sheet (120), formed to have lower thermal conductivity than the first insulator sheet, disposed opposite to the electrode sheet with respect to the heater-cum-shield wire, and joined to the second surface of the first insulator sheet by fusion of the first insulator sheet itself.

4. The electrostatic transducer according to claim 3, wherein
a portion of the heater-cum-shield wire is embedded in the second insulator sheet; and
another portion of the heater-cum-shield wire is in contact with or embedded in the first insulator sheet.

5. The electrostatic transducer according to claim 3, wherein
the second insulator sheet is formed containing foamed resin as a material having lower thermal conductivity than the first insulator sheet.

6. The electrostatic transducer according to claim 5, wherein,
in the second insulator sheet, a surface on the first insulator sheet side is formed in an open-cell state in which cells of the foamed resin are opened; and
the second insulator sheet is joined to the first insulator sheet by partial impregnation of the first insulator sheet.

7. The electrostatic transducer according to claim 1, further comprising:
a lead wire (40), comprising a core wire (40a), and a core wire covering material (40b) covering the core wire and formed containing a thermoplastic material, and comprising a portion disposed overlapping the first surface of the first insulator sheet and a portion disposed overlapping the electrode sheet;
in an electrical joining region (Pa) which is a region in a plane direction of the first insulator sheet and in which the electrode sheet and the core wire of the lead wire are disposed overlapping each other, an electrical joint (81) electrically joining the electrode sheet with the core wire of the lead wire; and
in an insulating joining region (Pb) which is a different region from the electrical joining region in the plane direction of the first insulator sheet and in which the first insulator sheet and the core wire covering material of the lead wire are disposed overlapping each other, an insulating joint (82) joining the first insulator sheet with the core wire covering material of the lead wire.

8. The electrostatic transducer according to claim 7, wherein
the insulating joint comprises a portion of the first insulator sheet.

9. The electrostatic transducer according to claim 7, further comprising:
in the electrical joining region, a joining restricting layer (60) disposed between the first insulator sheet and the electrode sheet and restricting joining between the first insulator sheet and the electrode sheet.

10. The electrostatic transducer according to claim 9, wherein
a portion of the joining restricting layer is disposed between the first insulator sheet and the core wire covering material of the lead wire in the insulating joining region; and
the insulating joint comprises a portion of the joining restricting layer, a portion of the first insulator sheet, and a portion of the core wire covering material of the lead wire.

11. The electrostatic transducer according to claim 9, wherein
the joining restricting layer comprises a material having a softening point higher than that of the first insulator sheet.

12. The electrostatic transducer according to claim 11, wherein
the joining restricting layer is a resin sheet formed containing a thermoplastic material.
